(19) United States
(12) Patent Application Publication
(10) Pub. No.: US 2018/0285954 A1
(43) Pub. Date: Oct. 4, 2018

(54) SYSTEM AND METHOD FOR SWITCHING UTILITY PROVIDERS

(71) Applicant: WIPRO LIMITED, BANGALORE (IN)

(72) Inventor: Vikesh SACHDEVA, SURREY (GB)

(73) Assignee: Wipro Limited

(21) Appl. No.: 15/474,390

(22) Filed: Mar. 30, 2017

(51) Int. Cl. G06Q 30/06; G06Q 50/06

(52) U.S. Cl. CPC G06Q 30/0627; G06Q 50/06

(57) ABSTRACT

Disclosed herein are a system and method for switching utility providers. The method includes receiving, by a utility switch, user preference input, distributed energy resources usage, real-time utility utilization details and tariff schemes of one or more utility providers. The method further includes creating, by the utility switch, a user utility usage profile, based on the user preference input and user usage pattern. The method includes analyzing by the utility switch, the tariff schemes of the one or more utility providers with at least one of the user utility usage profile, the distributed energy resources usage or the real-time utility utilization details. The method further includes, switching, by the utility switch, between the one or more utility providers, based on the analysis.

### TECHNICAL FIELD

This disclosure relates to utility distribution, and more particularly to a system and method for switching utility providers.

### BACKGROUND

The number of utility providers, including gas providers and electricity providers have increased. The different utility providers may have different tariff schemes. The customers also have an option to choose between a wide range of utility providers.

However, the process of changing from one provider to the other takes a lot of time and is a very tedious process. In an example, to change from one service provider to the other the user has to produce bill settlements for the current provider and in the UK the entire time required to change from one utility provider to the other takes around 21 days on an average.

Also, manual processes of comparing different schemes of different utility providers is a very tedious process, and much money and effort is required in the entire process.

### SUMMARY

In one embodiment, a method for switching utility providers has been disclosed. The method includes receiving, by a utility switch, user preference input, distributed energy resources usage, real-time utility utilization details and tariff schemes of one or more utility providers. The method further includes creating, by the utility switch, a user utility usage profile, based on the user preference input and user usage pattern. The method includes analyzing by the utility switch, the tariff schemes of the one or more utility providers with at least one of the user utility usage profile, the distributed energy resources usage or the real-time utility utilization details. The method further includes, switching, by the utility switch, between the one or more utility providers, based on the analysis.

In another embodiment, a system for switching utility providers is disclosed. The system includes at least one processor and a memory. The memory stores instructions that, when executed by the at least one processor, causes the at least one processor to perform operations including, receiving user preference input, distributed energy resources usage, real-time utility utilization details and tariff schemes of one or more utility providers. The operations further include creating a user utility usage profile, based on the user preference input and user usage pattern. The operations include analyzing the tariff schemes of the one or more utility providers with at least one of the user utility usage profile, the distributed energy resources usage or the real-time utility utilization details. The operations further include switching between the one or more utility providers, based on the analysis.

In another embodiment, a non-transitory computer-readable storage medium for switching utility providers is disclosed, which when executed by a computing device, cause the computing device to perform operations including, receiving user preference input, distributed energy resources usage, real-time utility utilization details and tariff schemes of one or more utility providers. The operations further include creating a user utility usage profile, based on the user preference input and user usage pattern. The operations include analyzing the tariff schemes of the one or more utility providers with at least one of the user utility usage profile, the distributed energy resources usage or the real-time utility utilization details. The operations further include switching between the one or more utility providers, based on the analysis.

### BRIEF DESCRIPTION OF THE DRAWINGS

The accompanying drawings, which are incorporated in and constitute a part of this disclosure, illustrate exemplary embodiments, and together with the description, serves to explain the disclosed principles.

FIG. 1 illustrates an exemplary network implementation for switching utility providers, in accordance with some embodiments of the present subject matter.

FIG. 2 illustrates a utility switch for switching utility providers, in accordance with some embodiments of the present subject matter.

FIG. 3 illustrates an exemplary method for switching utility providers, in accordance with some embodiments of the present subject matter.

FIG. 4 is a block diagram of an exemplary computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Embodiments of the present disclosure provide a system and method for switching utility providers. The present subject matter receives user preference as input. User preference may be that user prefers an environment conscious utility usage, or that the user prefers all the electrical appliances and gas powered appliance of her home to be switched off or regulated in use when there is no occupancy at home except a particular security appliances, where the security appliances may run on power from photo-voltaic cells. User preference may also include cost preferences of the user, where the user may want the least cost for her utility usage. Utilities may be electricity or gas for domestic usage. The user preferences may be received by a utility switch. The utility switch may then create a user usage pattern based on the user preferences and user usage pattern. The user usage pattern may be vary depending on the climatic conditions and time of the day and holiday profile. The utility switch may then analyze the user utility usage profile, real time utility usage details and other distributed energy resources by comparing them with tariff schemes of one or more utility providers. Subsequently after the comparison, the utility switch may switch the utility services from one service provider to the other based on the analysis.

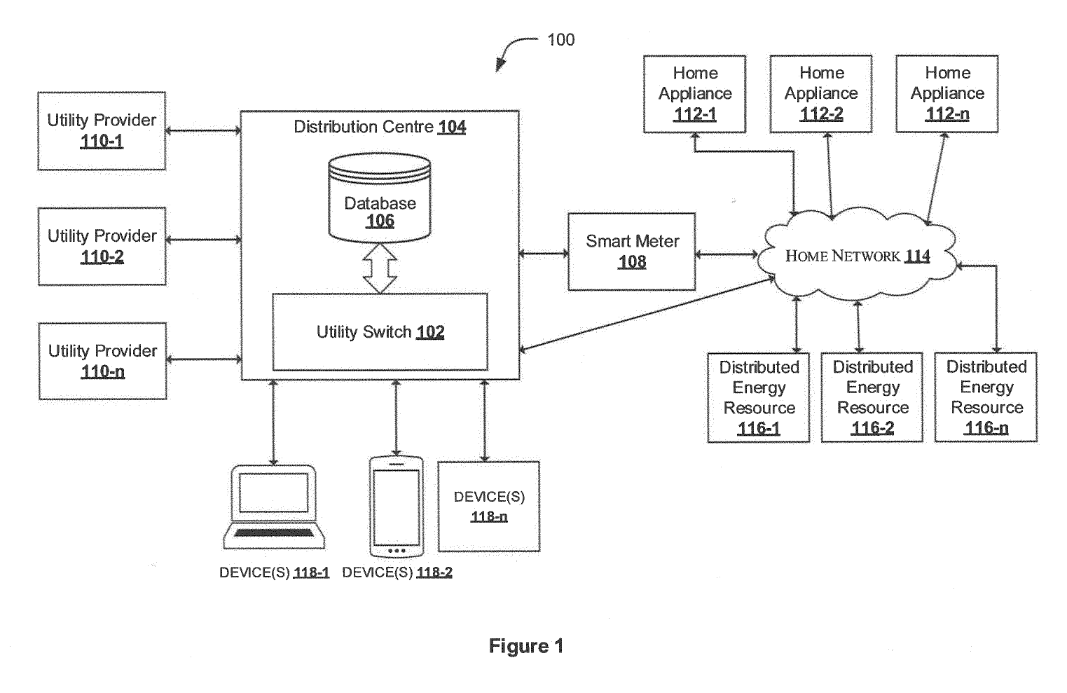

FIG. 1 illustrates an exemplary network implementation for switching utility providers, in accordance with some embodiments of the present subject matter.

Referring to FIG. 1, an exemplary system 100 comprising one or more components configured for switching utility providers is disclosed. The one or more components may include a plurality of Utility Providers (UP) 110-1, 110-2 . . . 110-n, which may be collectively and individually referred to as UPs 110, a Utility Switch (US) 102, a database 106, a distribution center (DC) 104, a smart meter 108, a plurality of home appliances 112-1, 112-2 . . . , 112-n which may be individually and collectively referred to as home appliances 112, a plurality of distributed energy resources 116-1, 116-2, . . . 116-n, which may be individually and collectively referred to as distributed energy resources (DER) 116 and a plurality of devices 118-1, 118-2 . . . 118-n, which may be individually and collectively referred to as devices 118. The above mentioned one or more components are communicatively coupled to each other.

The UPs 110 may be different utility providers. The UPs 110 may have their own tariff schemes. The UPs 110 may include both providers for domestic gas and electricity. However, the UPs 110 may not be responsible for distributing such utilities to the end customers or the home owners. The distribution of the utilities may be performed by the DC 104. The DC 104 may invoke a switch for distribution of the utilities to the different houses and keep a tab of the services subscribed by each house. In some embodiments, the DC 104 may be a hosted at a distribution company sight, including grids for distributing various utilities to various households. The smart meter 108 may be installed in each household, which are serviced by the DC 104. In an example, a smart meter 108 may be a gas and electricity meter that can digitally send meter readings and frequently usage profile data to the US 102. In an example, the user profile data may be sent half-hourly. The smart meter 108 may be communicate with the home appliances 112, and DER 116, through a home network 114.

The home network 114 may be a wireless network, wired network or a combination thereof. The home network 114, may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, ZigBee etc. The home network 114 may include, without limitation, a direct interconnection, local area network (LAN), wide area network (WAN), wireless network (e.g., using Wireless Application Protocol), the Internet, etc.

In an example, the home appliances 112 may include gas cooker, air conditioners, refrigerators, home security system, Heating systems, lights etc. In some embodiments, the DERs 116 may be smaller power sources or power storage units, that can be aggregated to provide power necessary to meet regular demand. In an example, the DERs 116 may be Lithium ion batteries, photo-voltaic cells, wind turbine etc.

In some embodiments, the utility usage of the home appliances 112 and the DERs 116 may be received by the smart meter 108 and or utility switch 102 through the home network 114. The smart meter may further communicate the utility usage data to the US 102. In some embodiments, the US 102 may be installed within the DC 104. In some other embodiments, the US 102 may be installed in the home environment. In an example, the US 102 may communicate with the smart meter 108 using dual network ZigBee and Wi-Fi protocols. In some other environments, the US 102 may also be hosted on a cloud. In an example, the smart meter 108 may communicate with the US 102 using transmission control protocol/internet protocol (TCP/IP), token ring, IEEE 802.11a/b/g/n/x, etc.

In some embodiments, the database 106 may include data regarding tariff schemes of different UPs 110. In some examples, the tariff scheme may include standing charges for utilities provided by different UPs 110, time of use tariff, standing charges etc. In some examples, the database 106 may be a local database within the US 102.

In some embodiments, the US 102 may analyze at least one of the user utility usage profile, distributed energy resources (DERs) 116 usage or real-time utility utilization details with tariff schemes of one or more utility providers, and switch the existing utility provider based on the analysis. In some embodiments, instead of switching, access to utilities may be blocked or regulated for a certain period of time based on the analysis.

The devices 118 may include, without limitation, personal computer(s), server(s), fax machines, printers, scanners, various mobile devices such as cellular telephones, smartphones ((e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. The devices 118 may interact with the US 102 using transmission control protocol/internet protocol (TCP/IP), token ring, IEEE 802.11a/b/g/n/x, etc.

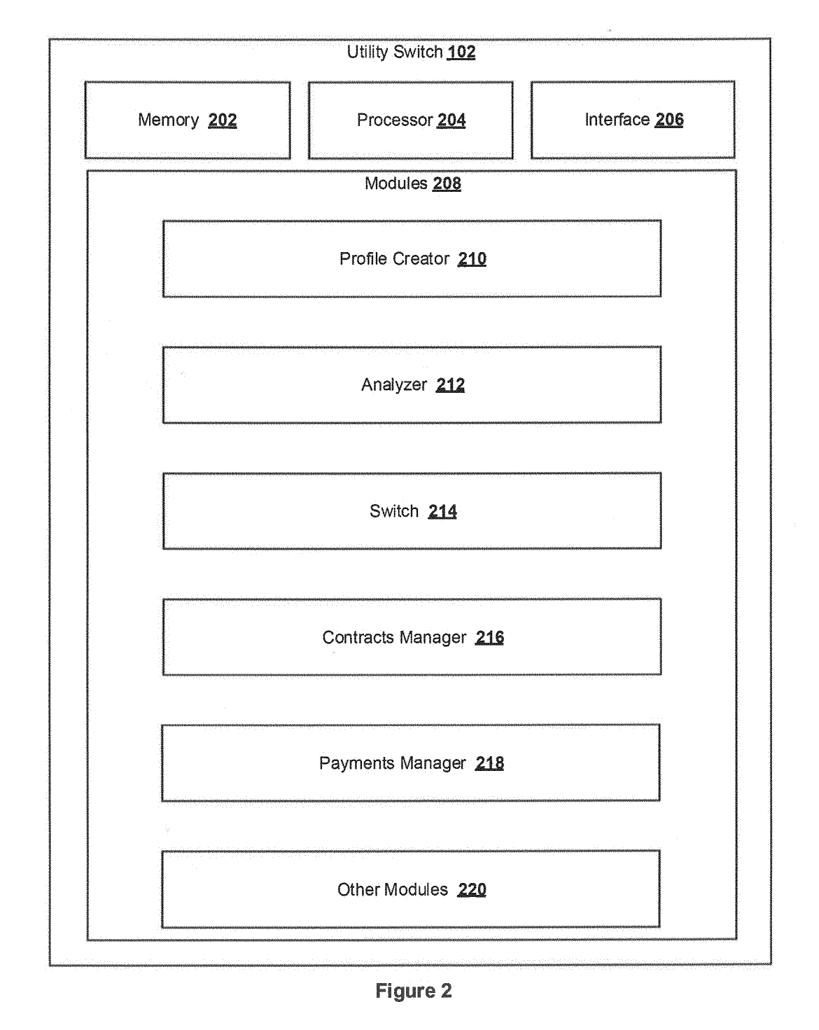

The US 102 for switching utility providers is explained in more detail in conjunction with FIG. 2. As shown in FIG. 2, the US 102, comprises of a processor 204, a memory 202 coupled to the processor 204, and interface(s) 206. The processor 204 may be implemented as one or more microprocessors, microcomputers, microcontrollers, digital signal processors, central processing units, state machines, logic circuitries, and/or any devices that manipulate signals based on operational instructions. Among other capabilities, the processor 204 is configured to fetch and execute computer-readable instructions stored in the memory 202. The memory 202 can include any non-transitory computer-readable medium known in the art including, for example, volatile memory (e.g., RAM), and/or non-volatile memory (e.g., EPROM, flash memory, etc).

The interface(s) 206 may include a variety of software and hardware interfaces, for example, a web interface, a graphical user interface, service layer like web services, JSON, Rest etc., allowing the US 102 to interact with the smart meter 108 and in some embodiments also with the database 106. Further, the interface(s) 206 may enable the US 102 respectively to communicate with other computing devices, The interface(s) 206 can facilitate multiple communications within a wide variety of networks and protocol types (Peripheral Component Interconnect (PCI), Universal Serial Bus (USB) etc), including wired networks, for example LAN, cable, etc., and wireless networks such as WLAN, cellular, or satellite. The interface(s) 206 may include one or more ports for connecting a number of devices to each other or to another server.

In one embodiment, the US 102 includes modules 208. In one embodiment, the modules 208 may be stored within the memory 206. In one example, the modules 208, amongst other things, include routines, programs, objects, components, and data structures, which perform particular tasks or implement particular abstract data types. The modules 208 may also be implemented as, signal processor(s), state machine(s), logic circuitries, and/or any other device or component that manipulate signals based on operational instructions. Further, the modules 208 can be implemented by one or more hardware components, by computer-readable instructions executed by a processing unit, or by a combination thereof.

In one implementation, the modules 208 further include a profile creator (PC) 210, an analyzer 212, a switch 214, a contracts manager (CM) 216 and a payments manager (PM) 218. In an example, the modules 208 may also comprise other modules 220. The other modules 220 may perform various miscellaneous functionalities of the US 102. It will be appreciated that such afore mentioned modules may be represented as a single module or a combination of different modules.

In operations, the PC 210 may create a user utility usage profile based on user preference input and user usage pattern. In some embodiments, the user preference input may be entered by the user through the devices 118. In an example, the user preferences may be related to user's environment conscience, commercial concerns over the electricity consumption. In an example, the user may indicate that she prefers using alternate energy majorly instead of the conventional electricity from the DERs 114. Hence for the user the photo-voltaic cells may be charged for a certain period of time, and electricity stored within them may be used to power the home appliances 112. Other preferences of a user may be cost, that is the user may want least cost for the use of utilities. In another example, user preference may also include a green-scheme. In an example, green-scheme may be the user's ability to buy renewable power from the grid based on the user's preference.

In some embodiments, the user usage pattern may be received by the PC 210 from the smart meter 108. In an example, the user usage pattern may be the daily usage of the devices of the user based on her daily routine. In an example, the user may be a working person having office hours from 9 am to 5 pm. Hence for the particular user, there is very less utilization of electricity for the user during that period. In another example, after office hours, the user may prefer to use the heater for a particular period of time. Hence all this utility consumption details may be detected by the smart meter and sent to the PC 210. The PC 210 based on the user usage pattern and the user preference input create the user utility usage profile.

The user utility usage profile may be sent by the PC 210 to the analyzer 212. The analyzer 212 may analyze at least one of the user utility usage profile, DERs 116 usage or real-time utility utilization details with tariff schemes of one or more utility providers. In an example, the real-time utility utilization details may be utility usage charges of current retailer, break-in conditions or standing charges of current retailer. In an example, a break-in condition may signify some penalty for a customer to exit a contract out of term. In some embodiments, the analysis may include comparing by the analyzer 210, the different tariff schemes for different utility providers along with an analysis of the different DERs 116. In some embodiments, analysis of the different DERs 116 may be the capacity of the DERs 116, and how cost effective usage of the different distributed resources may be. In an example, user preference input, stored in the user utility usage profile may be that the user wants his utility usage may be as environment friendly as possible. In such a case, if the user has sufficient capacity of photo-voltaic cells, then throughout the day time, the cells may be charged, and in the evenings, her utility requirements may be serviced from the photo-voltaic cells instead of from any other service provider.

In some embodiments, the analyzer 212 may choose a utility provider, based on the ecofriendly method of generation of energy resources. In an example, the user preference input may be that she wants green energy fueled utility usage, which may be stored as a part of the user utility usage profile. In such a case, the analyzer 212 may compare the different utility providers and select the utility provider creating energy from wind turbine, or harvesting tidal energy or nuclear energy. Here cost of such utility may go up, but the analyzer 212 will still select such utility provider. In another example, based on the user utility usage profile, the analyzer 212 may compare between different utility providers and select the utility provider providing energy harvested in an ecofriendly method and asking the lowest tariff.

In another example, if the standing charges of service provider B is lower than a service provider A, then the analyzer 212 may choose the service provider B, during the time user does not use the utilities. In another example, the analyzer will choose the service provider with the least peak time utility charges based on user's usage pattern during the peak time hours.

In another embodiment, over a course of a day, different utility providers may be selected by the analyzer 212 based on the user utility usage profile, real-time utility utilization data and DERs 116. In an example, the user utility usage profile may indicate that the user stays at home during off-peak hours and that the user is environment conscious, however tariff is also a concern for the user. Also, the user may have installed sufficient photo-voltaic cells as distributed resources. In such a case, the analyzer 212, may select a utility provider with the least off-peak tariff during the off-peak hours, the provider with the least tariff during the peak hour. The analyzer 212 may also be trained to calculate the amount of time taken by the photo-voltaic cells charge, and based on that the analyzer 212 may disconnect services from all other utility providers and select the photo-voltaic cells to cater to the user's different utility needs. Hence the analyzer may create the most cost effective way of using utilities customized to the user utility usage profile. In another example, the season or climatic changes may also bring about variations in tariff structures and user usage patterns, such changes may also be taken in account by the analyzer 212.

The analysis from the analyzer may be sent to the switch 214, which may in its turn switch the utility providers based on the analysis. Similar to the example, given above, based on the analyzer's analysis, the switch 214 may switch from one utility provider to the other during different times of the day and may also deactivate utility services during the time the distributed resources may cater to the user's utility requirements.

In some embodiments, the US 102 may be trained over a period of time. In an example, after gathering the user preference input and creating the user utility usage profile, based on the user preference input and the user usage pattern, the user utility usage profile along with all its details may be displayed to the user on the devices 118. The user may provide inputs or changes or validate the created profile details and over a period of time a confidence threshold for the created profile may be reached, after which user input may not be required.

In another example, the analysis of the analyzer 212 displayed to the user on the devices 118 may also be validated by the user over a period of time, till a confidence score for analysis is reached, after which user validation on the analysis may not be necessary. However, in some embodiments, the user may make edits to the analysis through the devices 218.

In some embodiments, the CM 216 may manage a contracts database, the contract database, wherein the contracts database, includes one or more agreements associated with the one or more utility providers. The agreements may be self-populated by the CM 216 based on the analysis of the analyzer 212 and switching of the switch 214. In an example, the agreements may mention the time of each day during which the services of particular utility providers were taken and the tariff rates. In some embodiments, the agreements may be displayed to the user on the devices 118.

In some embodiments, the PM 218 may manage payments for the services provided by different utility providers as per the agreements in the CM 216.

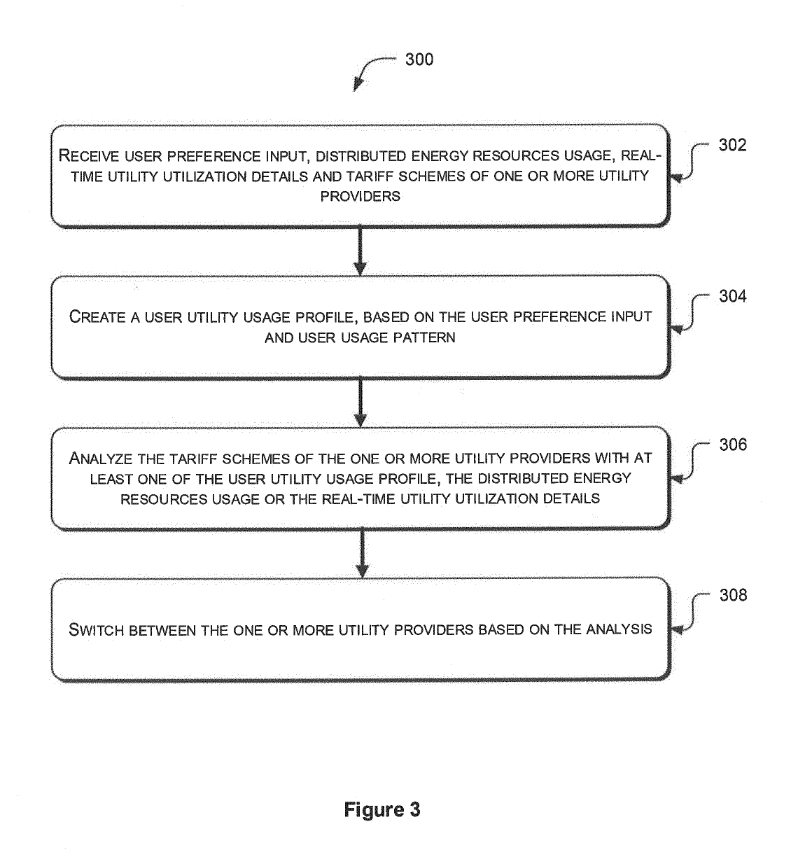

FIG. 3 illustrates an exemplary method for switching utility providers with some embodiments of the present disclosure.

The method 300 may be described in the general context of computer executable instructions. Generally, computer executable instructions can include routines, programs, objects, components, data structures, procedures, modules, and functions, which perform particular functions or implement particular abstract data types. The method 300 may also be practiced in a distributed computing environment where functions are performed by remote processing devices that are linked through a communication network. In a distributed computing environment, computer executable instructions may be located in both local and remote computer storage media, including memory storage devices.

Reference is made to FIG. 3, the order in which the method 300 is described is not intended to be construed as a limitation, and any number of the described method blocks can be combined in any order to implement the method 300 or alternative methods. Additionally, individual blocks may be deleted from the method 300 without departing from the spirit and scope of the subject matter described herein. Furthermore, the method 300 can be implemented in any suitable hardware, software, firmware, or combination thereof.

With reference to FIG. 3, at step 302, user preference input, distributed energy resources usage, real-time utility utilization details and tariff schemes of one and more utility providers may be received. In an example, the user preference input may be received from the devices 118 by the PC 210. In an example, the user preference inputs may be user cost preference, or an eco-friendly scheme. In an example, an eco-friendly scheme may be a green scheme. In some examples, the user preference input may that the user may want to pay least tariff for his utility usages and may also want to be as environment friendly as possible.

At step 304, a user utility usage profile may be created based on the user preference input and user usage pattern. In an example, the user usage pattern may be that the user may have maximum energy utilization during a particular time of the day and less energy consumption during other times of the day. In some embodiments, the PC 210 may create the user utility usage profile based on the user preference input and user usage pattern. In an example, the user usage pattern may be received from the smart meter 108.

The analyzer 212 may analyze the tariff schemes of the one or more utility providers with at least one of the user utility usage profile, the distributed energy resources 116 usage or the real-time utility utilization details at step 306.

In an example, the analyzer may compare the tariff schemes of different utility providers, and compare it with the real-time utility utilization details and select service providers keeping in to account the DERs 116 and the user utility usage profile.

In an example, the real-time utility utilization details include daily utility usage of the user based on weather conditions, utility usage charges of current retailer, break-in conditions or standing charges of current retailer. In another example, user usage pattern may vary depending upon the seasonal and climatic changes.

In some examples, the DERs 116 include one or more utility storage devices, wherein the one or more utility storage devices comprises photo-voltaic cells and batteries.

At step 308, the switch 214 may switch between the one or more utility providers for optimum utility billing, based on the analysis. In an example, the switching of utility providers may include switching more than once at different times of the day based on the analysis. In some embodiments, the switching may be effected by the switch 214 at the DC 104 invoking various industry data flow systems. In an example, the switch 214 may make the switch from UP 110-1 to UP 110-2 based on the analysis and the household may be serviced by the UP 110-2 through the various power and gas distribution assets owned by distribution companies.

in some embodiments, the database 106 may be updated based on the switching by the switch 214. In some other embodiments, the CM 216 may update the contracts as per the services availed by the user.

In an example, the user profile may include that the user is environment conscious and her working hours are between 9 am to 5 pm and cost is also a concern for the user. Hence, the switch 214 as per step 308 based on the analysis by the analyzer 212 at step 306 switch between different service providers as per peak time and non-peak time charges and also may suspend utility services based on the capacity and utilization of the DERs 116.

In some embodiments, a contract database may be managed by the US 102, wherein the contract database comprises one or more agreements associated with the one or more utility providers. The agreements in the CM 216 may be self populated base on the switching as per step 308.

In some other embodiments, the PM 218 may manage payments for the various services user as mentioned in the agreements stored in CM 216.

A few advantages of the present disclosure may include automation, transparency and complete control over switching of utility providers. Further the disclosure may help save huge sums of money per year for the customers. The disclosure may have a wider impact on how the demand and supply are managed on the distribution gird once combined with domestic renewable and storage solutions.

### Computer System

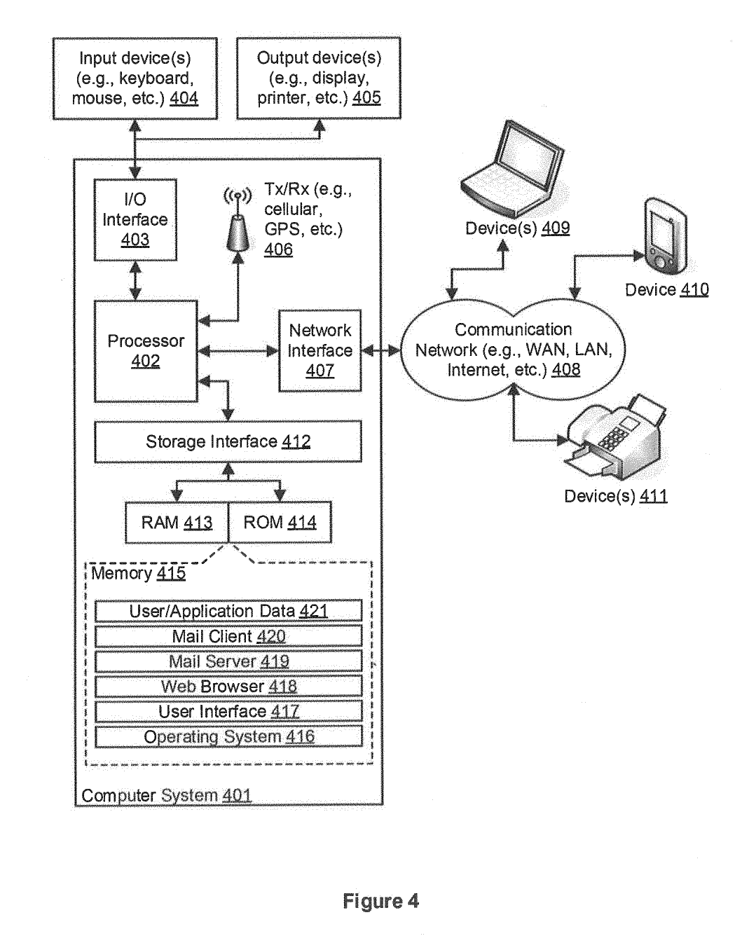

FIG. 4 is a block diagram of an exemplary computer system for implementing embodiments consistent with the present disclosure. Variations of computer system 401 may be used for implementing the devices and systems disclosed herein. Computer system 401 may comprise a central processing unit (“CPU” or “processor”) 402. Processor 402 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, ENC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 806 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e,g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412, The storage interface may connect to memory devices including, without limitation, memory drives, removable disc drives, etc., employing connection protocols such as serial advanced technology attachment (BATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc. Variations of memory devices may be used for implementing, for example, the databases disclosed herein.

The memory devices may store a collection of program or database components, including, without limitation, an operating system 416, user interface application 417, web browser 418, mail server 416, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUls) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML. Adobe Rash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Rash, JavaScript, Java, application programming interfaces (APs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The specification has described a system and method for switching utility providers. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional budding blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

We claim:

1. A method of switching utility providers, the method comprising:
receiving, by a utility switch, user preference input, distributed energy resources usage, real-time utility utilization details and tariff schemes of one or more utility providers;
creating, by the utility switch, a user utility usage profile, based on the user preference input and user usage pattern;
analyzing, by the utility switch, the tariff schemes of the one or more utility providers with at least one of the user utility usage profile, the distributed energy resources usage or the real-time utility utilization details; and
switching, by the utility switch, between the one or more utility providers based on the analysis.

2. The method of claim 1, wherein user preference comprises at least one of user cost preference, or an eco-friendly scheme.

3. The method of claim 1, wherein the real-time utility utilization details comprises daily utility usage of the user based on weather conditions, utility usage charges of current retailer or standing charges of current retailer.

4. The method of claim 1, wherein utility comprises energy resources, wherein the energy resources comprises gas resources and electricity resources for domestic and commercial usage.

5. The method of claim 1, wherein the distributed energy resources comprises one or more utility storage devices, wherein the one or more utility storage devices comprises photo-voltaic cells and batteries.

6. The method of claim 1, further comprising managing a contract database, wherein the contract database comprises one or more agreements associated with the one or more utility providers.

7. The method of claim 1, wherein switching between the one or more utility providers comprises switching at an energy distribution location.

8. A system for switching utility providers, comprising:
a hardware processor;
a memory storing instructions executable by the hardware processor for:
receiving user preference input, distributed energy resources usage, real-time utility utilization details and tariff schemes of one or more utility providers;
creating a user utility usage profile, based on the user preference input and user usage pattern;
analyzing the tariff schemes of the one or more utility providers with at least one of the user utility usage profile, the distributed energy resources usage or the real-time utility utilization details; and
switching between the one or more utility providers based on the analysis.

9. The system of claim 8, wherein user preference comprises at least one of user cost preference or an eco-friendly scheme.

10. The system of claim 8, wherein the real-time utility utilization details comprises daily utility usage of the user based on weather conditions, utility usage charges of current retailer or standing charges of current retailer.

11. The system of claim 8, wherein utility comprises energy resources, wherein the energy resources comprises gas resources and electricity resources for domestic and commercial usage.

12. The system of claim 8, wherein the distributed energy resources comprises one or more utility storage devices, wherein the one or more utility storage devices comprises photo-voltaic cells and batteries.

13. The system of claim 8, further comprising managing a contract database, wherein the contract database comprises one or more agreements associated with the one or more utility providers.

14. The system of claim 8, wherein switching between the one or more utility providers comprises switching at an energy distribution location.

15. A non-transitory computer-readable medium storing instructions for switching utility providers, wherein upon execution of the instructions by one or more processors, the processors perform operations comprising:
receiving user preference input, distributed energy resources usage, real-time utility utilization details and tariff schemes of one or more utility providers;
creating a user utility usage profile, based on the user preference input and user usage pattern;
analyzing the tariff schemes of the one or more utility providers with at least one of the user utility usage profile, the distributed energy resources usage or the real-time utility utilization details; and
switching between the one or more utility providers based on the analysis.

16. The medium of claim 15, wherein user preference comprises at least one of user cost preference or an eco-friendly scheme.

17. The medium of claim 15, further comprising generating an error report based on transmission faults in at least one of the transmission of the emergency response to the vehicle control unit, the receipt of the emergency action data from the at least one external server or the simulation of the receiver.

18. The medium of claim 15, wherein utility comprises energy resources, wherein the energy resources comprises gas resources and electricity resources for domestic and commercial usage.

19. The medium of claim 15, wherein the distributed energy resources comprises one or more utility storage devices, wherein the one or more utility storage devices comprises, photo-voltaic cells and batteries.

20. The medium as claimed in claim 15, further comprising managing a contract database, wherein the contract database comprises one or more agreements associated with the one or more utility providers.

21. The medium as claimed in claim 15, wherein switching between the one or more utility providers comprises switching at an energy distribution location.
